(19) United States
(12) Patent Application Publication
(10) Pub. No.: US 2019/0135241 A1
(43) Pub. Date: May 9, 2019

(54) SMART ACTIVATED RINSE SCAFFOLD

(71) Applicant: N/S CORPORATION, Inglewood, CA (US)

(72) Inventors: G. Thomas Ennis, Inglewood, CA (US); Alex Chavez, Hesperia, CA (US)

(21) Appl. No.: 16/151,120

(22) Filed: Oct. 3, 2018

Related U.S. Application Data
(60) Provisional application No. 62/567,340, filed on Oct. 3, 2017.

(51) Int. Cl. B60S 3/04

(52) U.S. Cl. CPC B60S 3/04

(57) ABSTRACT

Described is a smart activated rinse scaffold (e.g., arch). The arch includes multiple independent spray manifolds. Each spray manifold includes its own independently operate valve and corresponding nozzles that are configured to dispense fluid at different rates. A sensor system is included for determining a speed of an approaching vehicle and opening a valve to at least one of the spray manifolds based on the speed of the approaching vehicle. For example, a larger amount of volume is dispensed per time by a fast manifold on a fast approaching vehicle, while a smaller amount of volume of fluid is dispensed per time on a slowly approaching vehicle. Since the vehicles pass at different rates and the manifolds are opened to correspond to the rate, an approximately equal total volume of fluid is dispensed on different vehicles, regardless of the rate at which they pass through the rinsing arch.

### CROSS-REFERENCE TO RELATED APPLICATIONS

This is a non-provisional application of U.S. Provisional Application No. 62/567,340, filed on Oct. 3, 2017.

### BACKGROUND OF THE INVENTION

### (1) Field of Invention

The present invention relates to a rinsing system and, more particularly, to a smart rinsing arch for rinsing a passing vehicle.

### (2) Description of Related Art

Rinsing systems for rinsing vehicles have long been known in the art and come in a variety of forms. Rinsing arches, for example, have been devised that allow a driver to simply drive the bus underneath the arch. Such arches have a spray line that sprays water on the passing bus to rinse the bus. A problem with existing rinse arches it that they dispense water at a constant volume out of a single spray manifold, resulting in the amount of water that actually rinses the bus to vary depending on the speed of the bus. In other words, if a bus passes quickly beneath the arch, it receives a smaller amount of water than a bus that passes slowly beneath the art. Not only does this result in a variable spray depending on the speed of the bus, but also results in potentially wasted water.

Thus, a continuing need exists for a smart arch or scaffold that alters the volume of water being dispensed based on the speed of the passing vehicle, thereby applying approximately the same volume of water onto the vehicle regardless of the vehicle's speed and using water in the most efficient manner.

### SUMMARY OF INVENTION

The present invention relates to a rinsing system and, more particularly, to a rinsing scaffold (e.g., rinsing arch) for rinsing a passing vehicle. The rinsing arch includes multiple spray manifolds, nozzles, pump(s), and valves to rinse the passing vehicle, and sensors and circuity to determine the necessary volume of water to be dispensed based on the speed of the passing vehicle, thereby applying approximately the same volume of water onto the vehicle regardless of the vehicle's speed.

For example, the rinsing arch includes two or more independent spray manifolds. Each spray manifold includes its own independently operate valve and corresponding nozzles that are configured to dispense fluid at different rates. In various aspects, the nozzles for each manifold are different based on the rate (e.g., gallons per hour (gph)) that they are configured to dispense. A sensor system is included for determining a speed of an approaching vehicle and opening a valve to at least one of the spray manifolds based on the speed of the approaching vehicle. Thus, a larger amount of volume is dispensed per unit time by a fast manifold on a fast approaching vehicle, while a smaller amount of volume of fluid is dispensed per unit time on a slowly approaching vehicle. Since the vehicles pass at different rates and the manifolds are opened to correspond to the rate of the approaching vehicle, an approximately equal total volume of fluid is dispensed on different vehicles, regardless of the rate at which they pass through the rinsing arch.

In another aspect, each spray manifold includes a plurality of attached fluid nozzles, such that fluid nozzles in a first manifold are configured to dispense a greater volume of water per time than fluid nozzles in a second manifold.

In yet another aspect, the sensor system is operable for determining a speed of the approaching vehicle and categorizing the speed as a predefined speed category, with the corresponding valve being opened to a corresponding manifold based on the speed category.

In yet another aspect, the rinsing scaffold includes a fast manifold, a medium manifold, and a slow manifold, such that the sensor system categorizes the approaching vehicle as fast, medium, or slow, and opens the valve the fast, medium, or slow manifold based on the speed category.

In yet another aspect, the rinsing scaffold is formed in an arch shape such that each of the fast, medium, and slow manifolds surround a passing vehicle on at least three sides.

Finally, as can be appreciated by one in the art, the present invention also comprises a method for forming and using the invention described herein.

### BRIEF DESCRIPTION OF THE DRAWINGS

The objects, features and advantages of the present invention will be apparent from the following detailed descriptions of the various aspects of the invention in conjunction with reference to the following drawings, where:

FIG. 1A is an illustration of a smart activated rinse arch, depicting the arch in a system with sensors positioned on elevated structures to sense a passing vehicle according to various embodiments of the present invention;

FIG. 1B is an illustration of the smart activated rinse arch, depicting the arch in a system with one or more sensors positioned ahead of the passing vehicle according to various embodiments of the present invention;

FIG. 1C is an illustration of the smart activated rinse arch, depicting the arch in a system with one or more sensors positioned in the ground in order to detect vehicle weight or other aspects of the passing vehicle according to various embodiments of the present invention;

FIG. 2 is an illustration of the smart activated rinse arch, depicting the arch with outer panels; and

FIG. 3 is an illustration of the smart activated rinse arch, depicting the arch with the outer panels removed for illustrative purposes.

### DETAILED DESCRIPTION

The present invention relates to a rinsing system and, more particularly, to a rinsing arch for rinsing a passing vehicle. The following description is presented to enable one of ordinary skill in the art to make and use the invention and to incorporate it in the context of particular applications. Various modifications, as well as a variety of uses in different applications will be readily apparent to those skilled in the art, and the general principles defined herein may be applied to a wide range of embodiments. Thus, the present invention is not intended to be limited to the embodiments presented, but is to be accorded the widest scope consistent with the principles and novel features disclosed herein.

In the following detailed description, numerous specific details are set forth in order to provide a more thorough understanding of the present invention. However, it will be apparent to one skilled in the art that the present invention may be practiced without necessarily being limited to these specific details. In other instances, well-known structures and devices are shown in block diagram form, rather than in detail, in order to avoid obscuring the present invention.

The reader's attention is directed to all papers and documents which are filed concurrently with this specification and which are open to public inspection with this specification, and the contents of all such papers and documents are incorporated herein by reference. All the features disclosed in this specification, (including any accompanying claims, abstract, and drawings) may be replaced by alternative features serving the same, equivalent or similar purpose, unless expressly stated otherwise. Thus, unless expressly stated otherwise, each feature disclosed is only one example of a generic series of equivalent or similar features.

Furthermore, any element in a claim that does not explicitly state “means for” performing a specified function, or “step for” performing a specific function, is not to be interpreted as a “means” or “step” clause as specified in 35 U.S.C. Section 112, Paragraph 6. In particular, the use of“step of” or “act of” in the claims herein is not intended to invoke the provisions of 35 U.S.C. 112, Paragraph 6.

Please note, if used, the labels left, right, front, back, top, bottom, forward, reverse, clockwise and counter clockwise have been used for convenience purposes only and are not intended to imply any particular fixed direction. Instead, they are used to reflect relative locations and/or directions between various portions of an object.

(1) Description

The present invention relates to a rinsing system and, more particularly, to a rinsing scaffold (e.g., arch) for rinsing a passing vehicle with a plurality of independently controlled spray manifolds. In various aspects, each spray manifold is configured to dispense fluid at different rates to accommodate vehicles passing at varying speeds. Thus, the present invention is directed to any suitable mechanism or device that includes a plurality of spray manifolds that individually and/or collectively are operable for dispensing fluid at different rates. Described below is a non-limiting example of such a system; however, it should be understood that the invention is not intended to be limited thereto.

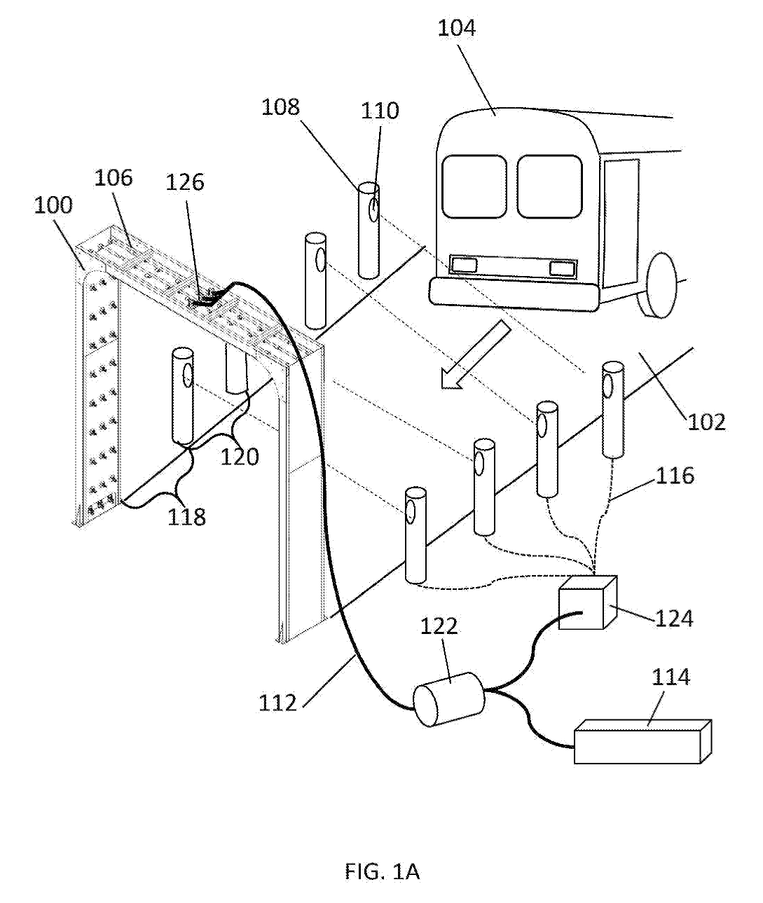

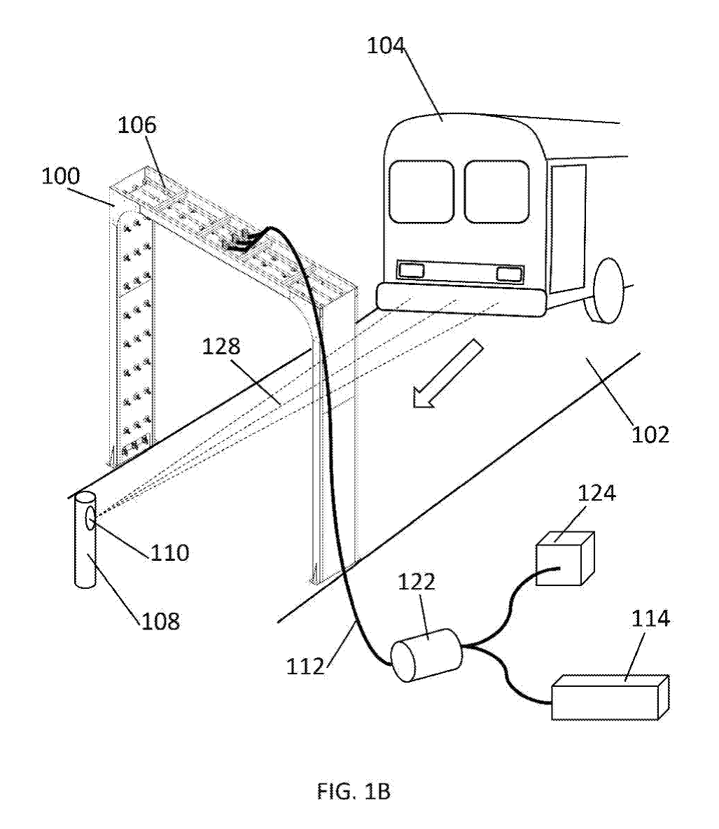

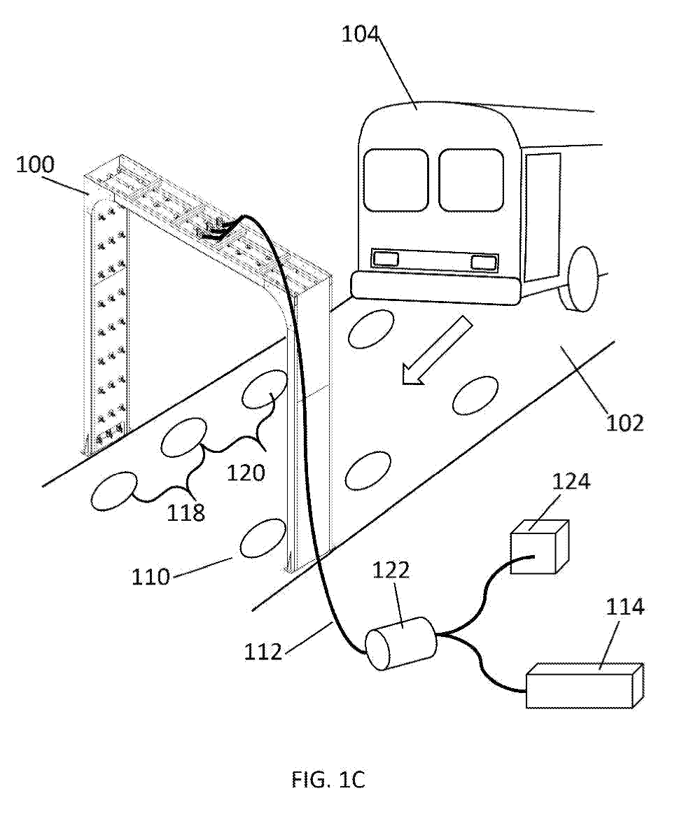

The rinsing system includes all of the piping, hardware, pumps, tubing, computers, and software or processing power as necessary in order to perform the operations as described herein. As shown in FIG. 1A, the rinsing scaffold is configured to be positioned proximate a pathway 102 for rinsing a passing vehicle 104. The rinsing scaffold can be formed in any suitable form or shape to maintain nozzles proximate a pathway 102 for rinsing the passing vehicle 104. In some aspects, the rinsing scaffold includes posts positioned lateral to the pathway 102 as a single post or a pair or more of posts that straddle the passing vehicle 104 on at least two sides (not illustrated). In other aspects, the rinsing scaffold is a hanging scaffold that hangs elevated over the pathway 102 to rinse the passing vehicle 104. In other embodiments and as shown in FIG. 1A, the rinsing scaffold is a rinsing arch 100 that is constructed to surround the passing vehicle 104 on three sides. Importantly, the rinsing scaffold (e.g., rinsing arch 100) includes a plurality of independent spray manifolds 106 (e.g., two, three, etc.). Thus, it should be understood that all of the components, features, and operations as described herein (e.g., manifolds, nozzles, etc.) with respect to the rinsing arch 100 can be equally implemented with any suitable shaped scaffold that positions the manifold and/or nozzles proximate the pathway 102 to rinse the passing vehicle 104. Thus, although a rinsing arch 100 is provided for illustrative purposes, the invention is not strictly limited to an arch shape as described and illustrated.

Each of the spray manifolds 106 are connected to independent and automatically controlled valves 126 (e.g., solenoid valve, etc.), which allows for independent control of each manifold 106. The spray manifolds 106 include the relevant piping and/or any other hardware or components as needed to discharge water into the path of the vehicle 104 (and ultimately onto the passing vehicle 104). For example, a plurality of spray nozzles 202 can be affixed with the piping for dispensing the water.

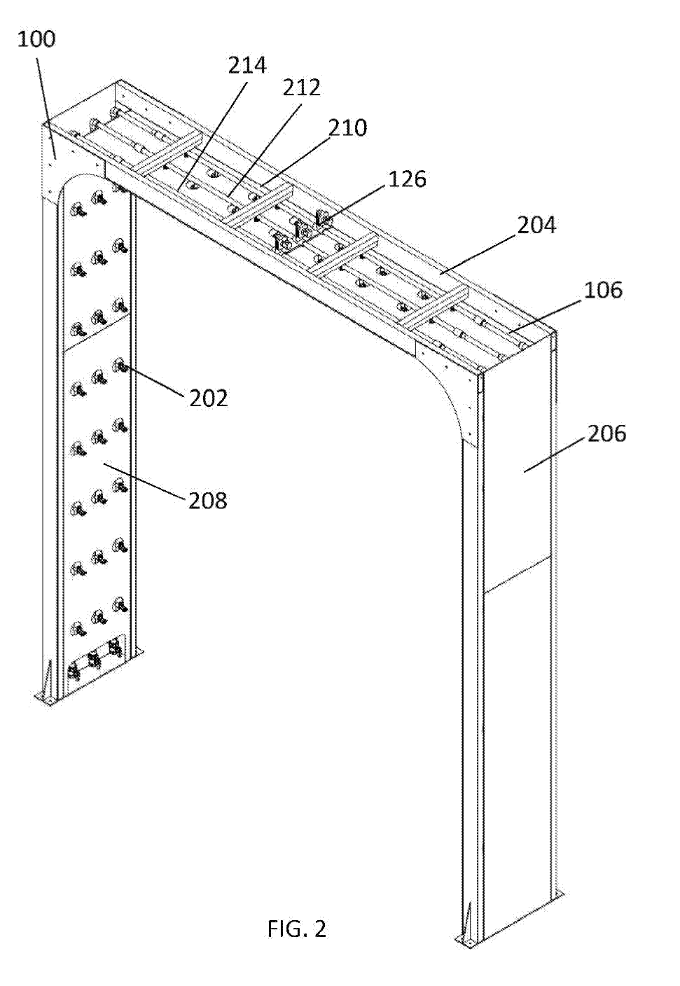

The valves 126 are depicted in greater detail in FIG. 2 and are discussed below. The spray manifolds 106 are provided fluid via a piping system 112 and a pump 122. The pump 122 provides fluid (e.g., water, wax, soap mix, etc.) from a designated fluid source 114, and is connected to a control system 124 (processor, computer, etc.) that determines when the fluid is to be released.

FIG. 1A also depicts one possible position of sensors 110. The sensors 110 are placed on elevated structures 108 in order for the sensor direction to be placed in the path 102 of the passing vehicle 104, with the system of sensors being communicatively connected to each other, and to the control system 124. The sensors are placed specified distances apart, with the first sensors positioned one distance 118 from the archway, and the remaining sensors positioned a secondary distance 120 away from the previous sensor. A more detailed example of this sensor placement is described below.

FIG. 1B depicts the rinsing arch 100 configured over the pathway 102 for rinsing a passing vehicle 104, with a secondary possibility of sensor 108 placement. The sensor 110 is placed on an elevated structure 110 in order to be placed in the path 102 of the passing vehicle 104, while also being placed sufficiently far ahead in order to sense the speed of the passing vehicle 104 as it approaches.

FIG. 1C depicts the rinsing arch 100 configured over the pathway 102 for rinsing a passing vehicle 104, with a third embodiment and possibility of sensor 110 placement. A plurality of sensors are placed on or within the ground, in order to detect the weight of the passing vehicle 104 as it travels. The first sensors are positioned one distance 118 from the archway, and the remaining sensors are positioned a secondary distance 120 away from the previous sensor.

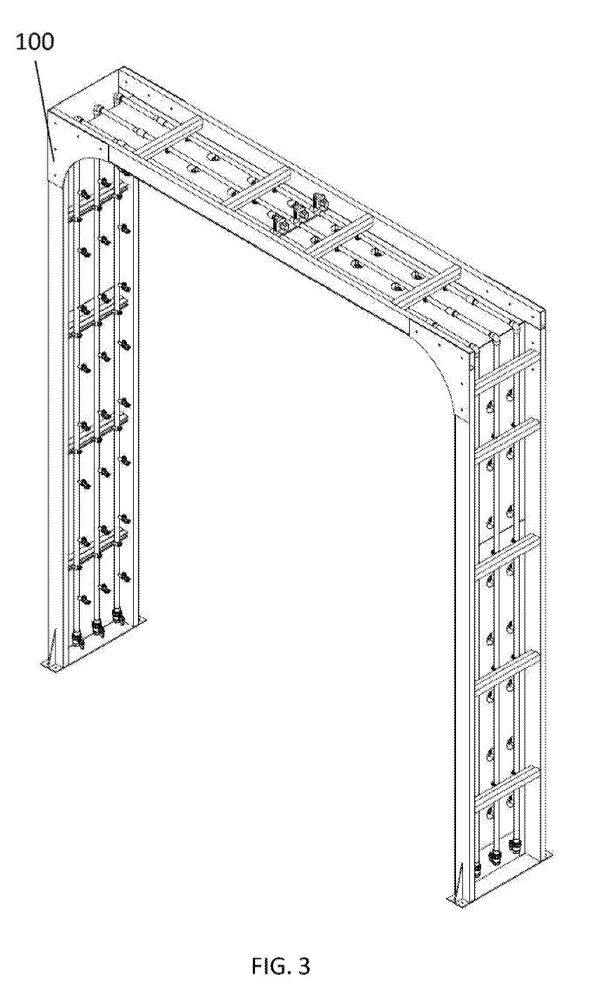

FIG. 2 depicts the rinsing arch 100 in greater detail, with the spray manifolds 106 spanning all sides of the arch. The rinsing arch is comprised of a suitable durable material 204 (e.g. aluminum, steel, etc.), and all sides are desirably covered in removable outer paneling 206 and inner paneling 208. The spray manifolds are designed and built so that each corresponds to a certain degree of fluid spray intensity. For example, a slow manifold 210 releases fluid at a low intensity (low volume), and a medium manifold 212 releases fluid at a medium intensity (medium volume), and a fast manifold 214 releases fluid at a high intensity (high volume), with respect to one another. For further illustration, FIG. 3 is an illustration of the smart activated rinse arch 100, depicting the arch 100 with the outer panels removed for illustrative purposes.

As a non-limiting example, sensor placement could be utilized as follows and as depicted in FIG. 1A. The first sensor 108 is positioned approximately three feet (or greater, or any other distance so long as the distance is known to the system to calculate the speed) from the arch 100 on the approach to the arch, while the other sensors are placed approximately four feet from one another (or greater, or any other distance so long as the distance is known to the system to calculate the speed). By knowing the distance between adjacent sensors and the time it takes for the approaching vehicle 104 to pass the adjacent sensors, the system can determine the speed of the approaching vehicle and designate the approaching vehicle as a predetermined category of speed, such as fast, medium, and slow. The predetermined categories are any suitable speed as designated by an operator provided there are at least two different speed categories. As a non-limiting example, the fast speed is between 5 and 3 miles per hour (mph), the medium speed is between 2.9 and 2 mph, and the slow speed is between 1.9 and 0.5 mph (or any other speed or range of speeds as set by an operator or preset into the system).

Based on the speed of the approaching vehicle 104, the system opens at least one of the designated valves 126 to allow water to enter the manifold 106 corresponding to that speed. For example, as shown in FIG. 2, one of the manifolds is a fast manifold 214, while another is a medium manifold 212, and the last is the slow manifold 210. Each manifold includes a plurality of water nozzles 202 that surround the passing vehicle 104 on at least three sides. In some embodiments, the nozzles sizes within and across the manifolds differ and some are the same. In other embodiments, the water nozzles 202 for each manifold 106 are different (while the same or approximately the same within any given manifold). For example, larger nozzles are positioned within the fast manifold and smaller nozzles (or at least some of the nozzles are smaller) are within the slow manifold. For example, the fast manifold 214 has larger nozzles that allow for a greater water of volume to pass through the nozzles per unit of time, while the medium manifold 212 has medium size nozzles that allow less water to pass through the medium nozzle (per unit of time) than the larger nozzles, and the slow manifold 210 has smaller sized nozzles that allow less water (per unit of time) to pass through the small nozzle than the medium nozzle. It should be understood that any suitable nozzles can be used, provided that collectively they vary in their ability to dispense the fluid or water. The nozzle sizes can vary based on customer requirements for the amount of volume to apply per vehicle, including automobile, bus, train, etc. As a non-limiting example, the fast manifold 214 has top nozzles across the top of the arch and side nozzles along the vertical sides of the arch, with the top nozzles each being configured to dispense 2 gallons per minute (GPM) and the side nozzles are each configured to dispense 1 and ½ GPM. Alternatively, the medium manifold 212 has top nozzles across the top of the arch and side nozzles along the sides of the arch, with the top nozzles of the medium manifold 212 each being configured to dispense 1 and ½ GPM and the side nozzles of the medium manifold 212 are each configured to dispense 1 GPM. Finally, the slow manifold 210 has top nozzles across the top of the arch and side nozzles along the sides of the arch, with the top nozzles of the slow manifold 210 each being configured to dispense 1 GPM and the side nozzles 210 of the slow manifold are each configured to dispense ½ GPM.

When the system determines that the approaching vehicle 104 is approaching at a fast speed, the system causes the valve 126 to the fast manifold 214 to open, thereby allowing water to enter the fast manifold 214 and spray fluid from the large sized nozzles onto the passing vehicle. Similarly, when the system determines that the approaching vehicle 104 is approaching at a medium speed, the system causes the valve 126 to the medium manifold 212 to open, thereby allowing water to enter the medium manifold 212 and spray from the medium sized nozzles onto the passing vehicle 104. Finally, when the system determines that the approaching vehicle 104 is approaching at a slow speed, the system causes the valve 126 to the slow manifold 210 to open, thereby allowing water to enter the slow manifold 210 and spray from the small sized nozzles onto the passing vehicle 104. The corresponding valve can be closed after the vehicle passes through the arch as determined by sensors or a predetermined amount of time after having opened the respective valve. Thus, based on the designated speed of the approaching vehicle 104, the system opens at least one of the designated valves 126 to allow water to enter the manifold 106 corresponding to that speed and, in doing so, is able to apply approximately the same volume of water to the passing vehicle 104 regardless of the speed of the vehicle. Repeated for clarity, if the vehicle is passing quickly, a larger volume of water is dispensed in a short period of time (via the fast manifold 214). Alternatively, if the vehicle is passing slowly, then water is dispensed more slowly over a longer period of time via the slow manifold 210. In doing so, approximately the same amount of water is actually dispensed onto the vehicle itself to provide the same rinse at all times, regardless of vehicle speed. Additionally, in this example, when the system dispenses water more slowly over a longer period of time while the vehicle is passing slowly, this allows the system to conserve water and use water more efficiently, as it is not wasting water by spraying unnecessarily fast.

What is claimed is:

1. A smart activated rinse scaffold, comprising:
a rinsing scaffold with two or more independent spray manifolds, each spray manifold being configured to dispense fluid at different rates and, wherein each spray manifold has its own independently operated valve; and
a sensor system for determining a speed of an approaching vehicle and opening a valve to at least one of the spray manifolds based on the speed of the approaching vehicle.

2. The smart activated rinse scaffold as set forth in claim 1, wherein each spray manifold includes a plurality of attached fluid nozzles, such that at least some fluid nozzles in a first manifold are configured to dispense a greater volume of water per unit time than at least some fluid nozzles in a second manifold.

3. The smart activated rinse scaffold as set forth in claim 2, wherein the sensor system is operable for determining a speed of the approaching vehicle and categorizing the speed as a predefined speed category, with the corresponding valve being opened to a corresponding manifold based on the speed category.

4. The smart activated rinse scaffold as set forth in claim 3, wherein the rinsing scaffold includes a fast manifold, a medium manifold, and a slow manifold, such that the sensor system categorizes the approaching vehicle as fast, medium, or slow, and opens the valve the fast, medium, or slow manifold based on the speed category.

5. The smart activated rinse scaffold as set forth in claim 4, wherein the rinsing scaffold is formed in an arch shape such that each of the fast, medium, and slow manifolds surround a passing vehicle on at least three sides.

6. The smart activated rinse scaffold as set forth in claim 2, wherein the sensor system is operable for determining a speed of the approaching vehicle and categorizing the speed as a predefined speed category, with the corresponding valve being opened to a corresponding manifold based on the speed category.

7. The smart activated rinse scaffold as set forth in claim 1, wherein the rinsing scaffold includes a fast manifold, a medium manifold, and a slow manifold, such that the sensor system categories the approaching vehicle as fast, medium, or slow, and opens the valve the fast, medium, or slow manifold based on the speed category.

8. The smart activated rinse scaffold as set forth in claim 7, wherein the rinsing scaffold is formed in an arch shape such that each of the fast, medium, and slow manifolds surround a passing vehicle on at least three sides.
